(19) United States
(12) Patent Application Publication
(10) Pub. No.: US 2023/0360841 A1
(43) Pub. Date: Nov. 9, 2023

(54) COIL COMPONENT

(71) Applicant: SAMSUNG ELECTRO-MECHANICS CO., LTD., Suwon-si (KR)

(72) Inventors: Ji Man RYU, Suwon-si (KR); Byeong Cheol MOON, Suwon-si (KR)

(73) Assignee: SAMSUNG ELECTRO-MECHANICS CO., LTD., Suwon-si (KR)

(21) Appl. No.: 18/098,893

(22) Filed: Jan. 19, 2023

(30) Foreign Application Priority Data
May 3, 2022 (KR) 10-2022-0054625

(51) Int. Cl. H01F 27/29

(52) U.S. Cl. CPC H01F 27/292

(57) ABSTRACT

A coil portion disposed in the body, and including a coil pattern including a plurality of turns, and a lead-out portion extended to one side surface of the body, and an external electrode disposed on the body and connected to the lead-out portion, wherein an outermost turn of the plurality of turns having a first region and a second region, and, wherein a line width of the second region is greater than a line width of the first region, and wherein the line width of the second region is greater than a line width of the most adjacent turn with the outermost turn.

### CROSS-REFERENCE TO RELATED APPLICATION(S)

This application claims the benefit of priority to Korean Patent Application No. 10-2022-0054625 filed on May 3, 2022 in the Korean Intellectual Property Office, the disclosure of which is incorporated herein by reference in its entirety.

### TECHNICAL FIELD

The present disclosure relates to a coil component.

### BACKGROUND

An inductor, a coil component, is a passive electronic component used in electronic devices along with a resistor and a capacitor.

As electronic devices have been designed to have high-performance and a reduced size, the number of electronic components used in electronic devices has been increased and sizes thereof have been reduced.

To implement a coil component having high capacity and high efficiency even in a small size, a coil pattern may need to be formed in a fine pattern, in which case delamination defects may occur.

### SUMMARY

An aspect of the present disclosure is to provide a coil component in which, by preventing delamination defects of a coil portion, the coil portion may have improved rigidity.

Another aspect of the present disclosure is to provide a coil component in which stiffness of a coil portion may be secured and a decrease in effective volume may be reduced.

Another aspect of the present disclosure is to provide a coil component in which bonding strength between a coil portion and an external electrode may improve and warpage of a substrate may be prevented.

According to an aspect of the present disclosure, a coil component includes a body, a coil portion disposed in the body, and including a coil pattern including a plurality of turns, and a lead-out portion extended to one side surface of the body, and an external electrode disposed on the body and connected to the lead-out portion, wherein an outermost turn of the plurality of turns having a first region and a second region, and wherein a line width of the second region is greater than a line width of the first region, and wherein the line width of the second region is greater than a line width of the most adjacent turn with the outermost turn.

### BRIEF DESCRIPTION OF DRAWINGS

The above and other aspects, features, and advantages of the present disclosure will be more clearly understood from the following detailed description, taken in conjunction with the accompanying drawings, in which:

FIG. 1 is a perspective diagram illustrating a coil component according to an example embodiment of the present disclosure;

FIG. 2 is an L-W cross-sectional diagram in FIG. 1;

FIG. 3 is a cross-sectional diagram taken along line I-I′ in FIG. 1;

FIG. 4 is a cross-sectional diagram taken along line II-II′ in FIG. 1;

FIG. 5 is a cross-sectional diagram taken along line in FIG. 1;

FIG. 6 is an L-W cross-sectional diagram illustrating a coil component according to a second embodiment, corresponding to FIG. 2;

FIG. 7 is an L-W cross-sectional diagram illustrating a coil component according to a third embodiment, corresponding to FIG. 2;

FIG. 8 is a perspective diagram illustrating a coil component according to a fourth embodiment of the present disclosure;

FIG. 9 is a cross-sectional diagram taken along line IV-IV′ in FIG. 8; and

FIG. 10 is a diagram illustrating a coil component according to a fifth embodiment of the present disclosure, corresponding to FIG. 9.

### DETAILED DESCRIPTION

The terms used in the example embodiments are used to simply describe an example embodiment, and are not intended to limit the present disclosure. The terminology used herein describes particular embodiments only, and the present disclosure is not limited thereby. As used herein, the singular forms “a,” “an,” and “the” are intended to include the plural forms as well, unless the context clearly indicates otherwise. The terms, “include,” “comprise,” “is configured to,” and the like, of the description are used to indicate the presence of features, numbers, steps, operations, elements, portions or combination thereof, and do not exclude the possibilities of combination or addition of one or more features, numbers, steps, operations, elements, portions or combination thereof.

Spatially relative terms, such as “above,” “upper,” “below,” and “lower” and the like, may be used herein for ease of description to describe one element's relationship to another element(s) as shown in the figures. It will be understood that the spatially relative terms are intended to encompass different orientations of the device in use or operation in addition to the orientation depicted in the figures. For example, if the device in the figures is turned over, elements described as “above,” or “upper” other elements would then be oriented “below,” or “lower” the other elements or features. Thus, the term “above” can encompass both the above and below orientations depending on a particular direction of the figures. The device may be otherwise oriented (rotated 90 degrees or at other orientations) and the spatially relative descriptors used herein may be interpreted accordingly. Also, the term “disposed on,” “placed on,” and the like, may indicate that an element is disposed on or beneath an object, and may not necessarily mean that the element is disposed on the object with reference to a gravity direction.

The term “coupled to,” “combined to,” and the like, may not only indicate that elements are directly and physically in contact with each other, but also include the configuration in which the other element is interposed between the elements such that the elements are also in contact with the other component.

The size and thickness of each component in the drawings may be arbitrarily indicated for ease of description, and thus, the present disclosure is not necessarily limited to the illustrated examples. The shape and size of constituent elements in the drawings may be exaggerated or reduced for clarity. In the drawings, for example, due to manufacturing techniques and/or tolerances, modifications of the shape shown may be estimated. Thus, embodiments of the present disclosure should not be construed as being limited to the particular shapes of regions shown herein, for example, to include a change in shape results in manufacturing. The following embodiments may also be constituted by one or a combination thereof.

The present disclosure may, however, be exemplified in many different forms and should not be construed as being limited to the specific embodiments set forth herein. Rather, these embodiments are provided so that this disclosure will be thorough and complete, and will fully convey the scope of the disclosure to those skilled in the art.

It will be apparent that though the terms first, second, third, etc. may be used herein to describe various members, components, regions, layers and/or sections, these members, components, regions, layers and/or sections should not be limited by these terms. These terms are only used to distinguish one member, component, region, layer or section from another region, layer or section. Thus, a first member, component, region, layer or section discussed below could be termed a second member, component, region, layer or section without departing from the teachings of the exemplary embodiments.

In the drawings, an L direction is a first direction or a length direction, a W direction is a second direction or a width direction, a T direction is a third direction or a thickness direction.

Hereinafter, a coil component according to an example embodiment will be described in detail with reference to the accompanying drawings, and in the description with reference to the accompanying drawings, the same or corresponding components may be provided with the same reference numerals and overlapping description thereof will not be provided.

In electronic devices, various types of electronic components may be used, and various types of coil components may be used between the electronic components to remove noise, or for other purposes.

In other words, in electronic devices, a coil component may be used as a power inductor, a high frequency inductor (HF inductor), a general bead, a high frequency bead (GHz bead), a common mode filter, and the like.

### First Embodiment

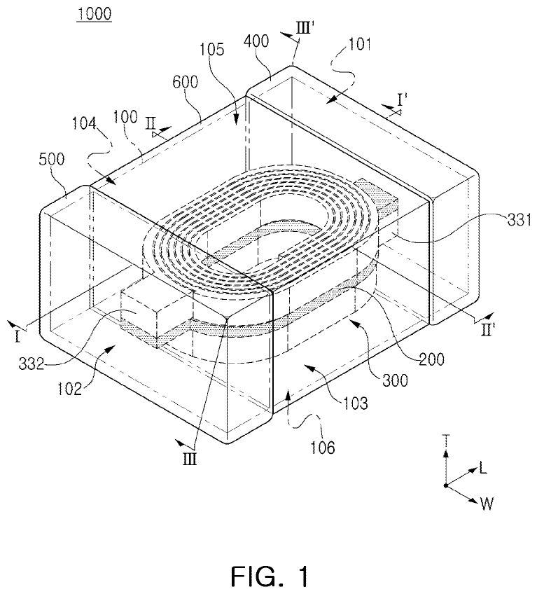

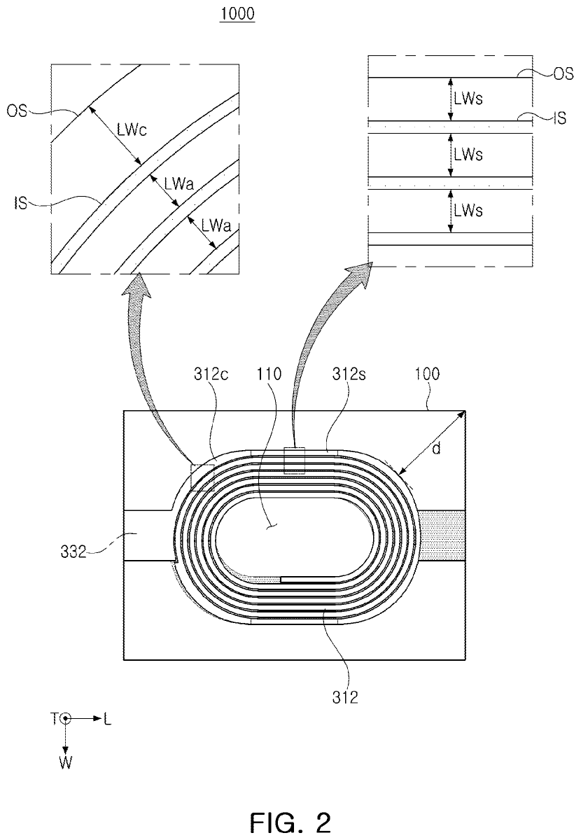

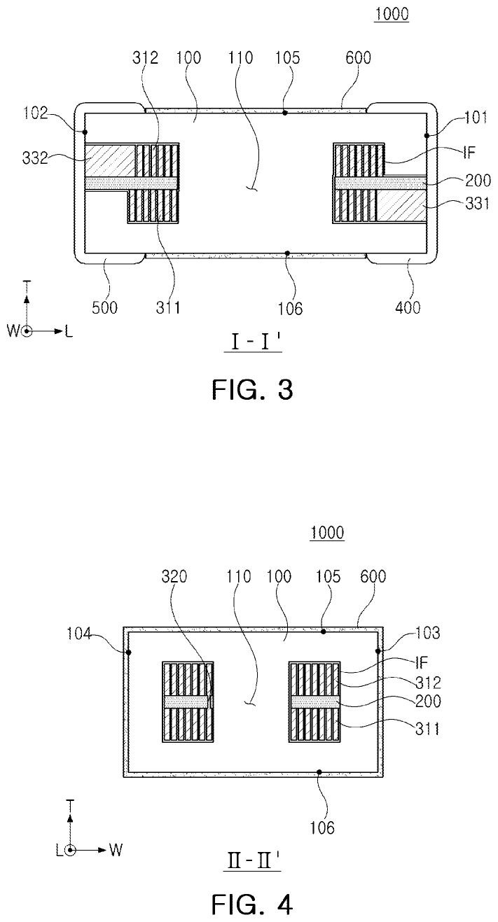

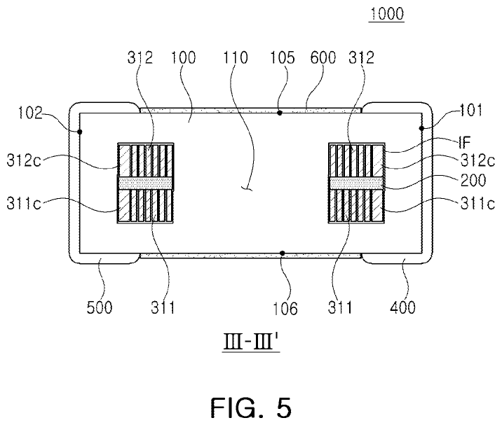

FIG. 1 is a perspective diagram illustrating a coil component according to an example embodiment. FIG. 2 is an L-W cross-sectional diagram in FIG. 1. FIG. 3 is a cross-sectional diagram taken along line I-I′ in FIG. 1. FIG. 4 is a cross-sectional diagram taken along line II-II′ in FIG. 1. FIG. 5 is a cross-sectional diagram taken along line III-III′ in FIG. 1.

Referring to FIGS. 1 to 5, the coil component 1000 according to the first embodiment may include a body 100, a substrate 200, a coil portion 300, and external electrodes 400 and 500. In some embodiments, the substrate 200 may not be provided.

The body 100 may form an exterior of the coil component 1000 in the example embodiment, and the substrate 200 and the coil portion 300 may be embedded therein.

The body 100 may have a substantially hexahedral shape. For example, in some embodiments, edges and/or corners of the body 100 may be rounded based on tolerances in the manufacturing process, and/or to avoid concentration of stresses at sharp edges and/or corners.

The body 100 may include a first surface 101 and a second surface 102 opposing each other in the length direction L, a third surface 103 and a fourth surface 104 opposing each other in the width direction W, and a fifth surface 105 and a sixth surface 106 opposing each other in the thickness direction T. Each of the first to fourth surfaces 101, 102, 103 and 104 of the body 100 may be a wall surface of the body 100 connecting the fifth surface 105 to the sixth surface 106 of the body 100.

The body 100 may be formed such that the coil component in which the external electrodes 400 and 500 are formed may have a length of 2.5 mm, a width of 2.0 mm and a thickness of 1.0 mm, may have a length of 2.0 mm, a width of 1.2 mm and a thickness of 1.0 mm, may have a length of 2.0 mm, a width of 1.2 mm and a thickness of 0.65 mm, may a length of 1.6 mm, a width of 0.8 mm and a thickness of 0.8 mm, may have a length of 1.0 mm, a width of 0.5 mm and a thickness of 0.5 mm, or may have a length of 0.8 mm, a width of 0.4 mm and a thickness of 0.65 mm, but an example embodiment thereof is not limited thereto. Since the above-described numerical value examples for the length, width, and thickness of the coil component 1000 do not reflect process errors, and a numerical value in a range recognized as a process error may correspond to the above-described numerical value examples.

The length of the above-described coil component 1000 may be a maximum value among dimensions of a plurality of line segments connecting two outermost boundary lines of the coil component 1000, opposing each other in the length direction L, to each other and in parallel to the length direction L, with respect to an optical microscope image or a scanning electron microscope (SEM) image with respect to a cross-section in the length-thickness L-T plane taken from the central portion of the coil component 1000 taken in the width direction W. Alternatively, the length of the coil component 1000 may refer to a minimum value among the dimensions of the plurality of line segments connecting two outermost boundary lines of the coil component 1000, opposing each other in the length direction L, to each other and in parallel to the length direction L. Alternatively, the length of the coil component 1000 may refer to an arithmetic mean value of at least three or more of the dimensions of the plurality of line segments described above. Here, the plurality of line segments parallel to the length direction L may be spaced apart from each other by an equal distance in the thickness direction T, but an example embodiment thereof is not limited thereto.

The thickness of the above-described coil component 1000 be a maximum value among dimensions of a plurality of line segments connecting two outermost boundary lines of the coil component 1000, opposing each other in the thickness direction T, to each other and in parallel to the thickness direction T, with respect to an optical microscope image or a scanning electron microscope (SEM) image with respect to a cross-section in the length-thickness L-T plane taken from the central portion of the coil component 1000 taken in the width direction W. Alternatively, the length of the coil component 1000 may refer to a minimum value among the dimensions of the plurality of line segments connecting two outermost boundary lines of the coil component 1000, opposing each other in the length direction T, to each other and in parallel to the length direction T. Alternatively, the length of the coil component 1000 may refer to an arithmetic mean value of at least three or more of the dimensions of the plurality of line segments described above. Here, the plurality of line segments parallel to the thickness direction T may be spaced apart from each other by an equal distance in the thickness direction T, but an example embodiment thereof is not limited thereto.

The width of the above-described coil component 1000 may be a maximum value among dimensions of a plurality of line segments connecting two outermost boundary lines of the coil component 1000, opposing each other in the width direction W, to each other and in parallel to the width direction W, with respect to an optical microscope image or a scanning electron microscope (SEM) image with respect to a cross-section in the length-width L-W plane taken from the central portion of the coil component 1000 taken in the thickness direction T. Alternatively, the width of the coil component 1000 may refer to a minimum value among the dimensions of the plurality of line segments connecting two outermost boundary lines of the coil component 1000, opposing each other in the width direction W, to each other and in parallel to the width direction W. Alternatively, the width of the coil component 1000 may refer to an arithmetic mean value of at least three or more of the dimensions of the plurality of line segments connecting two outermost boundary lines of the coil component 1000, opposing each other in the width direction W, to each other and in parallel to the width direction W. Here, the plurality of line segments parallel to the width direction W may be spaced apart from each other by an equal distance in the thickness direction T, but an example embodiment thereof is not limited thereto.

Alternatively, each of the length, width and thickness of the coil component 1000 may be measured by a micrometer measurement method. The micrometer measurement method may be a method of determining a zero point with a gage repeatability and reproducibility (R&R) micrometer, inserting the coil component 1000 of the example embodiment between tips of the micrometer, and measuring by turning a measuring lever of a micrometer. In measuring the length of the coil component 1000 by the micrometer measurement method, the length of the coil component 1000 may refer to a value measured once or may refer to an arithmetic average of values measured a plurality of times, which may be equally applied to the width and thickness of the coil component 1000.

The body 100 may include an insulating resin and a magnetic material. Specifically, the body 100 may be formed by laminating one or more magnetic composite sheets in which a magnetic material is dispersed in an insulating resin. However, the body 100 may have a structure other than the structure in which a magnetic material is dispersed in a resin. For example, the body 100 may be formed of a magnetic material such as ferrite, or may be formed of a non-magnetic material.

The magnetic material may be ferrite or metallic magnetic powder.

A ferrite powder may be at least one of, for example, spinel-type ferrite such as Mg—Zn-based ferrite, Mn—Zn-based ferrite, Mn—Mg-based ferrite, Cu—Zn-based ferrite, Mg—Mn—Sr-based ferrite, Ni—Zn-based ferrite, hexagonal ferrites such as Ba—Zn-based ferrite, Ba—Mg-based ferrite, Ba—Ni-based ferrite, Ba—Co-based ferrite, Ba—Ni—Co-based ferrite, garnet-type ferrites such as Y-based ferrite, and Li-based ferrites.

Metal magnetic powder may include one or more selected from a group consisting of iron (Fe), silicon (Si), chromium (Cr), cobalt (Co), molybdenum (Mo), aluminum (Al), niobium (Nb), copper (Cu) and nickel (Ni). For example, the magnetic metal powder may be at least one of pure iron powder, Fe—Si alloy powder, Fe—Si—Al alloy powder, Fe—Ni alloy powder, Fe—Ni—Mo alloy powder, Fe—Ni—Mo—Cu alloy powder, Fe—Co alloy powder, Fe—Ni—Co alloy powder, Fe—Cr alloy powder, Fe—Cr—Si alloy powder, Fe—Si—Cu—Nb alloy powder, Fe—Ni—Cr-based alloy powder and Fe—Cr—Al alloy powder.

The metal magnetic powder may be amorphous or crystalline. For example, the magnetic metal powder may be a Fe—Si—B—Cr amorphous alloy powder, but an example embodiment thereof is not limited thereto.

Each particle of ferrite and magnetic metal powder may have an average diameter of about 0.1 μm to 30 μm, but an example embodiment thereof is not limited thereto.

The body 100 may include two or more types of magnetic materials dispersed in a resin. Here, the different types of magnetic materials may indicate that the magnetic materials dispersed in the resin may be distinguished from each other by one of an average diameter, composition, crystallinity, and shape.

The insulating resin may include epoxy, polyimide, a liquid crystal polymer, or the like, alone or in combination but an example embodiment thereof is not limited thereto.

The body 100 may have a core 110 penetrating through the substrate 200 and the coil portion 300. The core 110 may be formed by filling the through-hole of the substrate 200 with a magnetic composite sheet, but an example embodiment thereof is not limited thereto.

The substrate 200 may be disposed in the body 100. The substrate 200 may be configured to support the coil portion 300. The substrate 200 may be absent depending on example embodiments in which the coil portion 300 is configured as a wound coil or to have a coreless structure.

The substrate 200 may be formed of a thermosetting insulating resin such as an epoxy resin, a thermoplastic insulating resin such as polyimide, or an insulating material including a photosensitive insulating resin, or an insulating material in which the insulating resin is impregnated with a reinforcing material such as glass fiber or inorganic filler. For example, the substrate 200 may be formed of an insulating material such as prepreg, Ajinomoto build-up film (ABF), FR-4, bismaleimide triazine (BT) film, and photo imaginable dielectric (PID) film, but an example embodiment thereof is not limited thereto.

As inorganic fillers, at least one selected from a group consisting of silica (SiO₂), alumina (Al₂O₃), silicon carbide (SiC), barium sulfate (BaSO₄), talc, mud, mica powder, aluminum hydroxide (Al(OH)₃), magnesium hydroxide (Mg(OH)₂), calcium carbonate (CaCO₃), magnesium carbonate (MgCO₃), magnesium oxide (MgO), boron nitride (BN), aluminum borate (AlBO₃), barium titanate (BaTiO₃) and calcium zirconate (CaZrO₃) may be used.

When the substrate 200 is formed of an insulating material including a reinforcing material, the substrate 200 may provide excellent rigidity. When the substrate 200 is formed of an insulating material not including glass fiber, it may be advantageous to reduce the thickness of the component by reducing the entire thickness (the sum of the dimensions of the coil unit 300 and the substrate 200 in the thickness direction T in FIG. 1) of the substrate 200 and the coil portion 300. When the substrate 200 is formed of an insulating material including a photosensitive insulating resin, the number of processes for forming the coil portion 300 may be reduced, which may be advantageous in reducing production costs, and fine vias 320 may be formed. The thickness of the substrate 200 may be, for example, in a range from about 10 μm to about 50 μm, but an example embodiment thereof is not limited thereto.

The coil portion 300 may be disposed on the substrate 200. The coil portion 300 may be embedded in the body 100 and may exhibit properties of the coil component. For example, when the coil component 1000 of the example embodiment is used as a power inductor, the coil 300 may store energy in a magnetic field and may maintain an output voltage, thereby stabilizing the power of the electronic device.

The coil portion 300 may be formed on at least one of both surfaces opposing each other of the substrate 200, and may form at least one turn. In the example embodiment, the coil portion 300 may include coil patterns 311 and 312, a via 320, and lead-out portions 331 and 332.

Referring to FIGS. 1 to 4, the first coil pattern 311 and the second coil pattern 312 may be disposed on both surfaces opposing each other of the substrate 200, respectively, and may have a plane spiral shape forming at least two turns about the core 110 of the body 100 as an axis. For example, the first coil pattern 311 may be disposed on the lower surface of the substrate 200 and may form at least two turns about the core 110 as an axis with respect to the direction in FIG. 1. The second coil pattern 312 may be disposed on the upper surface of the substrate 200 and may form at least two turns about the core 110 as an axis. Each of the first and second coil patterns 311 and 312 may have a shape in which the ends of outermost turns thereof connected to the lead-out portions 331 and 332 may extend in the first surface 101 and a second surface 102 of the body, respectively.

Referring to FIG. 2, an outermost turn of the coil patterns 311 and 312 may have a first region and a second region. A line width LWc of the second regions 311c and 312c may be greater than a line width LWs of the first regions 311s and 312s.

Also, the line width LWc of the second regions 311c and 312c may be configured to be larger than the line width LWa of the most adjacent turn with the outermost turn.

Here, the line width LWs of the first region 311s and 312s may refer to, for example, a minimum value among dimensions of a plurality of line segments connecting boundaries of each of the internal side surface IS and the external side surface OS, opposing each other, of the first regions 311s and 312s of the outermost turn illustrated in the drawings to each other and spaced apart from each other, with respect to an optical microscope image or a scanning electron microscope (SEM) image for a length direction (L)-width direction (W) cross-section taken from the central portion of the coil patterns 311 and 312 of the coil component 1000 in the thickness direction (T).

Also, the line width LWc of the second region 311c and 312c may refer to, for example, a maximum value among dimensions of a plurality of line segments connecting boundaries of each of the internal side surface IS and the external side surface OS, opposing each other, of the second regions 311c and 312c of the outermost turn illustrated in the drawings to each other and spaced apart from each other.

In the coil component 1000 according to the example embodiment, the reason for configuring the line width LWc of the second region 311c and 312c of the outermost turn to be relatively large may be as below.

When the coil patterns 311 and 312 are formed by electroplating and the seed layer is etched, a delamination defect in which a portion of the coil patterns 311 and 312 is delaminated from the substrate 200 may occur. This defect may greatly occur in the outermost turn of which the region exposed to the etchant is widest.

Accordingly, when the coil patterns 311 and 312 are formed, the line width of the outermost turn, which is the region most vulnerable to the delamination defect, may be configured to be relatively large, thereby effectively reducing the delamination defect during the etching process.

When the line width of each turn of the coil patterns 311 and 312 is increased, the number of turns may be reduced within a limited component size, and inductance properties may be reduced. Accordingly, it may be effective to configure the line width of only the outermost turns to be relatively large, to configure the line width of the other turn to be relatively small.

Also, when the overall line width of the outermost turn is configured to be large, inductance may decrease due to a decrease in the volume of the magnetic material in the body 100, and the defect in which the coil patterns 311 and 312 may be extended to the surface 103 or the fourth surface 104 of the body 100 during the dicing process by a chip unit may occur.

Therefore, to secure a dicing margin while reducing the reduction in effective volume within the same component size, the structure in which the line width LWc may be configured to be large only for the second regions 311c and 312c of the outermost turns of the coil patterns 311 and 312 may be effective. That is, in the outermost turns of the coil patterns 311 and 312, the line width LWc of the second regions 311c and 312c may be configured to be larger than the line width LWs of the first regions 311s and 312s.

Referring to FIG. 2, for ease of description, the boundary between the first regions 311s and 312s and the second regions 311c and 312c forming the outermost turns of the coil patterns 311 and 312 is indicated by a dotted line, but the first regions 311s and 312s and the second regions 311c and 312c may be integrated with each other such that no boundary may appear, and each of the first regions 311s and 312s and the second regions 311c and 312c may refer to a predetermined region.

The outermost turns of the coil patterns 311 and 312 may have the internal side surface IS directed to the adjacent turns and the external side surface OS opposing the internal side surface IS.

The first regions 311s and 312s may refer to regions in which curvatures of the internal side surface IS and the external side surface OS may be zero. The second regions 311c and 312c may refer to a region in which the curvature of at least one of the internal side surface IS and the external side surface OS is greater than zero.

Referring to FIG. 2, the line width LWc of the second regions 311c and 312c of the coil patterns 311 and 312 may be greater than the line width LWs of the first regions of the adjacent turns.

Also, in the coil patterns 311 and 312, at least one of the turns other than the outermost turns may have a constant line width. That is, at least one of the turns other than the outermost turns in the coil patterns 311 and 312 may have a linear portion and a curved portion having substantially the same line width. Here, the configuration in which the line widths are substantially the same may include process errors or positional deviations occurring during the manufacturing process, and errors during measurement.

The line width LWs of the first region 311s and 312s of the coil pattern 311 and 312 may be configured to be substantially the same as the line width LWa of the turn most adjacent to the outermost turn in the coil patterns 311 and 312.

The line widths of the other turns other than the outermost turns of the coil patterns 311 and 312 may be configured to be substantially the same. That is, the line widths LWs of the first regions 311s and 312s of the coil patterns 311 and 312 may be configured to be substantially the same as the line widths of the other turns other than the outermost turns.

FIG. 4 is a cross-sectional diagram taken along line II-II′ in FIG. 1. FIG. 5 is a diagonal cross-section of the coil component 1000 according to the example embodiment, that is, a cross-section taken along line III-III′ in FIG. 1.

Referring to FIGS. 2, 4 to 5, FIG. 4 illustrates a cross-section in which the line width LWs of the first region 311s and 312s of the outermost turn of the coil pattern 311 and 312 and the line width of the other turns appear, and the line width LWs of the first regions 311s and 312s may be substantially the same as the line widths of the other turns.

FIG. 5 illustrates a cross-section in which the line width LWc of the second regions 311c and 312c of the outermost turns of the coil patterns 311 and 312 and the line widths of the other turns appear, and the line width LWc of the second regions 311c and 312c of the outermost turns of the coil patterns 311 and 312 may be configured to be greater than the line widths of the other turns.

Referring to FIGS. 1 and 2, the body 100 may have a plurality of side surfaces 101, 102, 103, and 104, the line width LWc of the second regions 311c and 312c of the outermost turn of the coil pattern 311 and 312 may be configured to be greatest in the region in which the distance d between the edge at which the two side surfaces of the body 100 meet and the second region is the minimum.

Here, the distance d between the edge at which the two side surfaces of the body 100 meet and the second region may refer to, for example, a minimum value among dimensions of a plurality of line segments connecting tangents of the outermost turns of the coil patterns 311 and 312 from vertices of the body 100 illustrated in the drawings, and spaced apart from each other, with respect to an optical microscope image or a scanning electron microscope (SEM) image for a length (L)-width (W) cross-section taken from the central portion of the coil patterns 311 and 312 of the coil component 1000 in the thickness direction (T). Alternatively, the distance d may be measured using the ImageJ program for the image, but an example embodiment thereof is not limited thereto.

Referring to FIG. 2, the maximum line width LWc of the second regions 311c and 312c of the outermost turn may be in a range from 1.5 to 4 times the line width LWa of the turn most adjacent to the second regions 311c and 312c.

Also, the ratio (LWc/LWs) of the maximum line width LWc of the second regions 311c and 312c to the line width LWs of the first regions 311s and 312s may be in a range from 1.5 to 4.

Table 1 below lists data of measuring the effective volume and inductance of the body in units of the ratio of delamination defects occurs after the etching process was performed in units of panels before dicing, and in units of coil components. Measurement conditions were based on 30 seconds of water washing process (wet process) during etching per panel, and the line width of the first region 311s and 312s was 15 μm, the number of turns was 8.5 turns, the thickness was 100 μm, and the space between adjacent turns was 8 μm.

Referring to Table 1, according to the result of the experiment, when the ratio (LWc/LWs) of the maximum line width LWc of the second regions 311c and 312c to the line width LWs of the first regions 311s and 312s is less than 1.5, the delamination defect rate did not decrease significantly, and when the ratio (LWc/LWs) of the maximum line width LWc of the second regions 311c and 312c to the line width LWs of the first regions 311s and 312s exceeded 4, the effective volume and inductance reduction rate of the body 100 exceeded 10%, which is the allowable reference value.

Accordingly, by configuring the ratio (LWc/LWs) of the maximum line width LWc of the second regions 311c and 312c to the line width LWs of the first regions 311s and 312s to be 1.5 or more and 4 or less, the delamination defect may be reduced and an effective volume greater than the reference value may be assured.

TABLE 1

| ratio (LWc/LWs) | | | | | |
|---|---|---|---|---|---|
| between maximum | | | | | |
| line widths of | Delam- | Effective volume | | | |
| first region and | ination | of body | | Inductance | |
| second region of | defect rate | | Change | Ca- | Change |
| outermost turn | per panel | Volume | Rate | pacity | Rate |
| (LWc/LWs) | (%) | (mm³) | (%) | (uH) | (%) |
| 1 (ref.) | 8 | 256.88 | 100 | 0.9032 | 100 |
| 1.5 | 0 | 252.525 | 98.3 | 0.898 | 99.4 |
| 2 | 0 | 248.235 | 96.6 | 0.892 | 98.8 |
| 3 | 0 | 239.59 | 93.3 | 0.857 | 94.9 |
| 4 | 0 | 231.14 | 90.0 | 0.821 | 90.9 |

Referring to FIG. 3, the first lead-out portion 331 may be extended to the first surface 101 of the body 100, may be in contact with and connected to the first external electrode 400, and the second lead-out portion may be extended to the second surface 102 of the body 100 and may be in contact with and connected to the second external electrode 500.

Referring to FIG. 4, the via 320 may penetrate the substrate 200 and may connect the inner ends of the innermost turns of the first and second coil patterns 311 and 312 to each other.

Through this structure, the coil portion 300 may function as a single coil.

At least one of the coil patterns 311 and 312, the via 320, and the lead-out portions 331 and 332 may include at least one conductive layer.

For example, when the first coil pattern 311, the via 320, and the first lead-out portion 331 are formed on the lower surface of the substrate 200 (with respect to the direction in FIG. 1) by plating, each of the first coil pattern 311, the via 320, and the first lead-out portion 331 may include a seed layer and an electrolytic plating layer. The seed layer may be formed by an electroless plating method or a vapor deposition method such as sputtering. Each of the seed layer and the electroplating layer may have a single-layer structure or a multiple-layer structure. The electroplating layer having a multilayer structure may be formed in a conformal film structure in which one electroplating layer is covered by the other electroplating layer, and one electroplating layer may be laminated only on the other electroplating layer. The seed layer of the first coil pattern 311, the seed layer of the via 320, and the seed layer of the first lead-out portion 331 may be integrally formed such that a boundary may not be formed therebetween, but an example embodiment thereof is not limited thereto. The electroplating layer of the first coil pattern 311, the electroplating layer of the via 320, and the electroplating layer of the first lead-out portion 331 may be integrally formed such that a boundary may not be formed therebetween, but an example embodiment thereof is not limited thereto.

Each of the coil patterns 311 and 312, the via 320, and the lead-out portions 331 and 332 may include a conductive material such as copper (Cu), aluminum (Al), silver (Ag), tin (Sn), gold (Au), nickel (Ni), lead (Pb), titanium (Ti), chromium (Cr), molybdenum (Mo), or alloys thereof, but an example embodiment thereof is not limited thereto.

The external electrodes 400 and 500 may be disposed on the first surface 101 and the second surface 102 of the body 100, respectively, and may be connected to the first and second lead-out portions 331 and 332, respectively. Specifically, the first external electrode 400 may be disposed on the first surface 101 of the body 100 and may be in contact with the first lead-out portion 331. Also, the second external electrode 500 may be disposed on the second surface 102 of the body 100 and may be in contact with the second lead-out portion 332.

The external electrodes 400 and 500 may electrically connect the coil component 1000 to the printed circuit board when the coil component 1000 according to the example embodiment is mounted on a printed circuit board. For example, the external electrodes 400 and 500 spaced apart from each other on the first surface 101 and the second surface 102 of the body 100 may be electrically connected to the connection portion of the printed circuit board.

The external electrodes 400 and 500 may be formed of a conductive material such as copper (Cu), aluminum (Al), silver (Ag), tin (Sn), gold (Au), nickel (Ni), lead (Pb), chromium (Cr), titanium (Ti), an alloy thereof, but an example embodiment thereof is not limited thereto.

Each of the external electrodes 400 and 500 may include a plurality of layers. For example, the first external electrode 400 may include a first layer in contact with the first lead-out portion 331 and a second layer disposed on the first layer. Here, the first layer may be a conductive resin layer including a conductive powder including at least one of copper (Cu) and silver (Ag) and an insulating resin, or may be a copper (Cu) plating layer. The second layer may have a double layer structure of a nickel (Ni) plating layer/tin (Sn) plating layer.

Referring to FIGS. 3 to 5, the insulating film IF may be disposed between the coil portion 300 and the body 100 to cover the coil portion 300. The insulating film IF may be formed along the surfaces of the substrate 200 and the coil portion 300. The insulating film IF may be provided to insulate the coil portion 300 from the body 100 and may include a well-known insulating material such as parylene, but an example embodiment thereof is not limited thereto. The insulating film IF may be formed by a method such as vapor deposition, but an example embodiment thereof is not limited thereto, and the insulating film IF may be formed by laminating an insulating film on both surfaces of the substrate 200.

The coil component 1000 according to the example embodiment may further include an insulating layer 600 covering the third to sixth surfaces 103, 104, 105, and 106 of the body 100, and disposed in the region other than the region in which the external electrodes 400 and 500 are disposed.

The insulating layer 600 may be formed by, for example, coating and curing an insulating material including an insulating resin on the surface of the body 100. In this case, the insulating layer may include at least one of a thermoplastic resin such as polystyrene resin, vinyl acetate resin, polyester resin, polyethylene resin, polypropylene resin, polyamide resin, rubber resin, and acrylic resin, a thermosetting resin such as phenolic resin, epoxy resin, urethane resin, melamine resin, and alkyd resin and a photosensitive insulating resin.

### Second and Third Embodiments

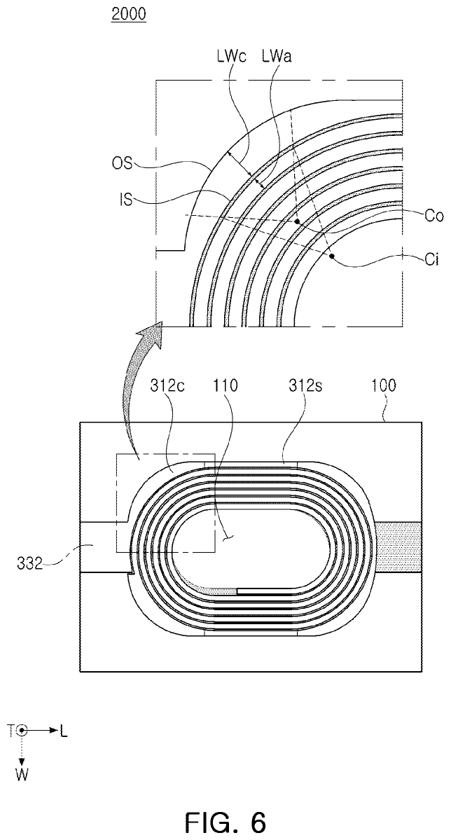

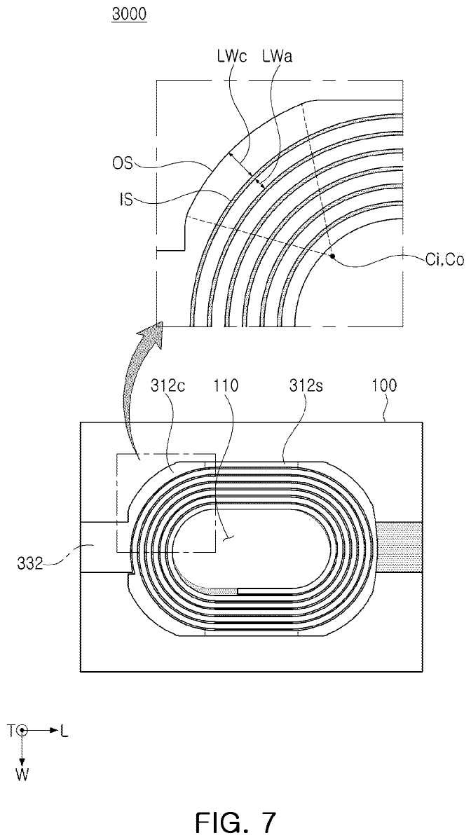

FIG. 6 is an L-W cross-sectional diagram illustrating a coil component according to a second embodiment, corresponding to FIG. 2. FIG. 7 is an L-W cross-sectional diagram illustrating a coil component according to a third embodiment, corresponding to FIG. 2.

Comparing the examples in FIGS. 6 and 7 with the example in FIG. 2, the line width LWc of the second region 312c of the outermost turn of the second coil pattern 312 may be configured to be larger.

Therefore, in describing the example embodiment, only the line width LWc of the second region 312c of the outermost turn, and a curvature and the center of curvature of the internal side surface IS and the external side surface OS, different from the first embodiment, will be described, and for the rest of the components of the example embodiment, the description in the first embodiment may be applied as is.

Referring to FIG. 6, in the structure in which the line width of the second region 312c of the outermost turn of the second coil pattern 312 is configured to be larger than the line width of the first region 312s, curvatures of the internal side surface IS and the external side surface OS of the region having the largest line width LWc in the second region 312c of the outermost turn may be configured to be different.

Also, the curvature of the external side surface OS of the region of the second regions 312c of the outermost turn of the second coil pattern 312 in which the line width is the largest may be configured to be greater than the curvature of the internal side surface IS.

The curvature and the line width of the outermost turn may be controlled when forming the pattern of the seed layer of the coil patterns 311 and 312, and in the coil component 2000 according to the example embodiment, the pattern may be formed such that the curvature of the external side surface OS of the outermost turn may be configured to be larger than the curvature of the internal side surface IS, and accordingly, the center of curvature Ci of the internal side surface IS of the outermost turn may be formed more adjacent to the core 110 than the center Co of curvature of the outer surface OS.

When increasing the line width LWc of the second regions 311c and 312c while changing the external side surface OS curvature as in the coil component 2000 according to the example embodiment, there may be the effect in which a dicing margin between the third surface 103 or the fourth surface 104 and the coil patterns 311 and 312 may be properly maintained, and the decrease in effective volume reduction may be reduced.

Referring to FIG. 7, in the structure in which the line width of the second region 312c of the second coil pattern 312 is configured to be larger than the line width of the first region 312s, the internal side surface IS and the external side surface OS of the region of the second region 312c which has the largest line width LWc may be configured to share the centers Ci and Co of curvature. That is, curvatures of the internal side surface IS and the external side surface OS of the region in the second region 312c of the outermost turn in which the line width LWc is the largest may be configured to be substantially the same. Here, the configuration in which the curvatures are substantially the same may include process errors or positional deviations occurring during the manufacturing process, and errors during measurement.

The curvature and line width of the outermost turn may be controlled when forming the pattern of the seed layer of the coil patterns 311 and 312, and in the coil component 3000 according to the example embodiment, the curvature of the external side surface OS of the outermost turn may be may be configured to have the same value as that of the curvature of the internal side surface IS, and accordingly, the center Ci of curvature of the internal side surface IS of the outermost turn may coincide with the center Co of curvature of the external side surface OS.

When increasing the line width LWc of the second regions 311c and 312c while maintaining the curvature of the external side surface OS to be constant as in the coil component 3000 according to the example embodiment, the region in which the line width LWc of the second regions 311c and 312c is relatively large may increase, such that rigidity may be further assured, and a process of forming a pattern having desired inductance properties may be easily performed.

### Fourth and Fifth Embodiments

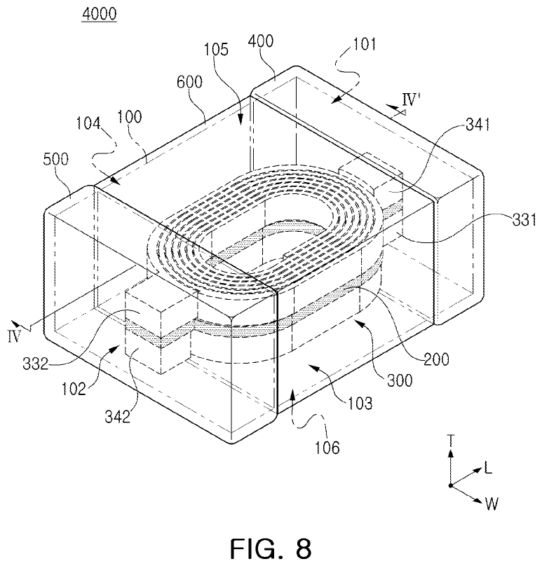

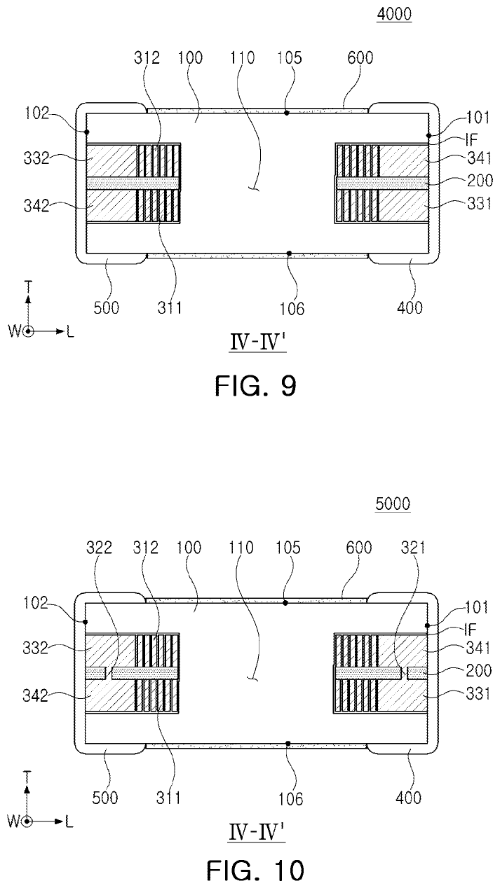

FIG. 8 is a perspective diagram illustrating a coil component 4000 according to a fourth embodiment. FIG. 9 is a cross-sectional diagram taken along line IV-IV′ in FIG. 8. FIG. 10 is a diagram illustrating a coil component 5000 according to a fifth embodiment of the present disclosure, corresponding to FIG. 9.

Comparing FIGS. 1 and 3, and FIGS. 8 and 9, the coil component 4000 according to the fourth embodiment may be different from the coil component 1000 according to the first embodiment in that the coil portion 300 may further include sub-lead-out portions 341 and 342 in the coil component 4000.

Therefore, in describing the example embodiment, only the sub-lead-out portions 341 and 342 different from the first embodiment will be described, and for the rest of the components of the example embodiment, the description in the first embodiment may be applied as is.

The sub-lead-out portions 341 and 342 may be disposed adjacent to the outermost turns of the coil patterns 311 and 312 and may reduce the region in which the outermost turns are exposed to the etchant in the etching process, thereby addressing the delamination defect.

Also, sub-lead-out portions 341 and 342 may be provided to strengthen fixing strength of the coil portion 300 and the external electrodes 400 and 500 or to prevent warpage due to an asymmetric structure of the upper and lower portions of the substrate 200.

Referring to FIGS. 8 and 9, the first and second sub-lead-out portions 341 and 342 may be disposed on the surfaces corresponding to the first and second draw-outs 331 and 332 with respect to the substrate 200, respectively.

Specifically, the first sub-lead-out portion 341 may be spaced apart from the second coil pattern 312 and may be disposed on the other surface of the substrate 200 to be connected to the first external electrode 400. Also, the first sub-lead-out portion 341 may be spaced apart from the first lead-out portion 331 with respect to the substrate 200.

The second sub-lead-out portion 342 may be disposed on one surface of the substrate 200 to be spaced apart from the first coil pattern 311 and to be connected to the second external electrode 500. Also, the second sub-lead-out portion 342 may be spaced apart from the second lead-out portion 332 with respect to the substrate 200.

Meanwhile, the first and second sub-lead-out portions 341 and 342 may not be provided, or only one of the first and second sub-lead-out portions 341 and 342 may not be provided.

In the example embodiment, since the first and second sub-lead-out portions 341 and 342 are not electrically connected to the coil patterns 311 and 312, and may thus not be provided, but in the coil component 4000 including the first and second sub-lead-out portions 341 and 342, the effect in which the delamination defect of the outermost turn may be prevented, the adhesion strength between the coil portion 300 and the external electrodes 400 and 500 may be strengthened, and warpage of the substrate 200 may be prevented may be obtained.

Also, in the effect of prevention of delamination defect of the outermost turns of the coil patterns 311 and 312, by combining the configuration in which the line width LWc of the second regions 311c and 312c of the outermost turns is configured to be relatively large with the sub-lead-out portion 341 and 342, the effect of prevention of delamination defect may further improve.

Comparing FIGS. 9 and 10, the coil component 5000 according to the fifth embodiment may be different from the coil component 4000 according to the fourth embodiment in that the coil component 5000 may further include sub-vias 321 and 322.

Therefore, in describing the example embodiment, only the sub-vias 321 and 322 different from the fourth embodiment will be described, and for the rest of the components of the example embodiment, the description in the fourth embodiment may be applied as is.

The first and second sub-vias 321 and 322 may be configured to penetrate the substrate 200 and to connect the lead-out portions 331 and 332 to the sub-lead-out portions 341 and 342, thereby connecting the sub-lead-out portions 341 and 342. When the first and second sub-vias 321 and 322 are disposed, the surfaces on which the sub-lead-out portions 341 and 342 are in contact with the external electrodes 400 and 500 may be electrically connected, thereby reducing overall Rdc.

Also, the first and second sub-vias 321 and 322 may penetrate the substrate 200 and may connect the lead-out portions 331 and 332 to the sub-lead-out portions 341 and 342, thereby improving rigidity of the coil portion 300.

Referring to FIG. 10, the first sub-via 321 may penetrate the substrate 200 and may connect the first lead-out portion 331 to the first sub-lead 341, and the second sub-via 322 may penetrate the substrate 200 and may connect the second lead-out portion 332 to the second sub-lead-out portion 342.

Meanwhile, the first and second sub-vias 321 and 322 may not be provided, and only one of the first and second sub-vias 321 and 322 may not be provided.

At least one of the first and second sub-lead-out portions 341 and 342 and the first and second sub-vias 321 and 322 may include at least one conductive layer.

For example, when the first sub-lead-out portion 341 and the first sub-via 321 are formed on the other surface of the substrate 200 by plating, each of the first sub-lead-out portion 341 and the first sub-via 321 may include a seed layer and an electroplating layer. Here, the electroplating layer may have a single-layer structure or a multiple-layer structure. The electroplating layer having a multilayer structure may be formed in a conformal film structure in which an electroplating layer may be formed along the surface of the other electroplating layer, and an electroplating layer may be formed only on the other surface of one of the electroplating layers. The seed layer may be formed by an electroless plating method or a vapor deposition method such as sputtering. The seed layers of the first sub-lead-out portion 341 and the first sub-via 321 may be integrally formed such that a boundary may not be formed therebetween, but an example embodiment thereof is not limited thereto. The electroplating layers of the first sub-lead-out portion 341 and the first sub-via 321 may be integrally formed such that a boundary may not be formed therebetween, but an example embodiment thereof is not limited thereto.

Each of the first sub-lead-out portion 341 and the first sub-via 321 may be formed of a conductive material such as copper (Cu), aluminum (Al), silver (Ag), tin (Sn), gold (Au), and nickel (Ni), lead (Pb), titanium (Ti), chromium (Cr), or an alloy thereof, but an example embodiment thereof is not limited thereto.

According to the aforementioned example embodiments, by addressing the delamination defect, a coil component having a coil portion having improved rigidity may be provided.

Also, a coil component in which rigidity of the coil portion is improved and the effective volume is reduced may be provided.

Also, a coil component in which adhesion strength between the coil portion and the external electrode is improved and warpage of the substrate is prevented may be provided.

While the example embodiments have been illustrated and described above, it will be apparent to those skilled in the art that modifications and variations could be made without departing from the scope of the present disclosure as defined by the appended claims.

What is claimed is:

1. A coil component, comprising:
a body;
a coil portion disposed in the body, and including a coil pattern including a plurality of turns, and a lead-out portion extended to one side surface of the body; and
an external electrode disposed on the body and connected to the lead-out portion,
wherein an outermost turn of the plurality of turns having a first region and a second region, and a line width of the second region is greater than a line width of the first region, and
wherein the line width of the second region is greater than a line width of the most adjacent turn with the outermost turn.

2. The coil component of claim 1, wherein the most adjacent turn has a constant line width.

3. The coil component of claim 1,
wherein the body has a plurality of side surfaces, and
wherein the line width of the second region is largest in a region in which a distance between an edge at which two side surfaces of the body meet and the second region is minimum.

4. The coil component of claim 1,
wherein the outermost turn has an internal side surface opposing the adjacent turn, and an external side surface opposing the internal side surface, and
wherein a curvature of an internal side surface and an external side surface of the first region is 0, and a curvature of at least one of the internal side surface and the external side surface of the second region is greater than 0.

5. The coil component of claim 4, wherein, in a part of the second region which has the largest line width, the curvature of the internal side surface is different from a curvature of the external side surface.

6. The coil component of claim 5, wherein, in the part of the second region which has the largest line width, the curvature of the external side surface is greater than the curvature of the internal side surface.

7. The coil component of claim 4, wherein, in the part of the second region which has the largest line width, the internal and external side surfaces share a center of curvature.

8. The coil component of claim 1, wherein a maximum line width LWc of the second region is in a range from 1.5 to 4 times a line width LWa of a turn most adjacent to the second region.

9. The coil component of claim 1, wherein a ratio (LWc/LWs) of the maximum line width LWc of the second region to the line width LWs of the first region is in a range from 1.5 to 4.

10. The coil component of claim 8, wherein a ratio (LWc/LWs) of the maximum line width LWc of the second region to the line width LWs of the first region is in a range from 1.5 to 4.

11. The coil component of claim 1, further comprising:
a substrate disposed within the body,
wherein the coil portion further includes first and second coil patterns disposed respectively on the first and second surfaces of the substrate, a via penetrating through the substrate and connecting inner ends of the first and second coil patterns to each other, and first and second lead-out portions extending from outer ends of the first and second coil patterns to both side surfaces of the body, respectively, and
wherein the external electrode includes a first external electrode connected to the first lead-out portion, and a second external electrode connected to the second lead-out portion.

12. The coil component of claim 11,
wherein the coil portion further includes:
a first sub-lead-out portion disposed on the second surface of the substrate, spaced apart from the second coil pattern, and connected to the first external electrode, and
a second sub-lead-out portion disposed on the first surface of the substrate, spaced apart from the first coil pattern, and connected to the second external electrode.

13. The coil component of claim 12, wherein the coil portion further includes:
a first sub-via penetrating through the substrate and connecting the first lead-out portion to the first sub-lead-out portion; and
a second sub-via penetrating through the substrate and connecting the second lead-out portion to the second sub-lead-out portion.

14. A coil component, comprising:
a body;
a coil portion encapsulated within the body and comprising a coil pattern including a plurality of coil turns, an outermost turn of the plurality of turns having a first region and a second region, and a line width of the second region is greater than a line width of remainder of the coil pattern; and
an external electrode disposed on a side surface of the body and connected to a lead-out portion of the coil pattern extending from the outermost turn to the side surface.

15. The coil component of claim 14, wherein a line width of the first region is equal to the line width of the first region of an adjacent turn adjacent to the outermost turn.

16. The coil component of claim 14, wherein the line width of the second region is largest in a region in which a distance between an edge at which two side surfaces of the body meet.

17. The coil component of claim 14, wherein a ratio (LWc/LWs) of the maximum line width LWc of the second region to the line width LWs of the first region is in a range from 1.5 to 4.

18. The coil component of claim 14, wherein a ratio (LWc/LWa) of maximum line width LWc of the second region to a line width LWa of a first adjacent turn most adjacent to the outermost turn is in a range from 1.5 to 4.
